(19) United States
(12) Patent Application Publication
(10) Pub. No.: US 2011/0016298 A1
(43) Pub. Date: Jan. 20, 2011

(54) Configuration File

(76) Inventor: William G. McCollom, Fort Collins, CO (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/505,142

(22) Filed: Jul. 17, 2009

(51) Int. Cl. G06F 9/00; G06F 17/30; H04L 9/32; G06F 17/00

(52) U.S. Cl. 713/1; 715/224; 707/E17.01; 713/168; 715/760

(57) ABSTRACT

A method for configuring a machine including launching an administrative safe mode on the machine when a secured configuration file is detected on a removable storage medium and extracting metadata from the secured configuration file to populate one or more settings fields on the machine that the secured configuration file identifies to configure.

### BACKGROUND

When configuring a machine, a user identifies a model of the machine and the components associated with the model. Once the model and the components of the machine have been identified, the user accesses one or more input devices on the machine and continues to manually enter and modify various settings or entries on the machine until the user is satisfied with a configuration of the machine.

### BRIEF DESCRIPTION OF THE DRAWINGS

Various features and advantages of the disclosed embodiments will be apparent from the detailed description which follows, taken in conjunction with the accompanying drawings, which together illustrate, by way of example, features of the embodiments.

FIG. 1 illustrates an exemplary machine with a security key coupled to a removable storage medium and a secured configuration file stored on the removable storage medium according to an embodiment of the invention.

FIG. 2 illustrates a block diagram of an exemplary configuration manager authenticating a secured configuration file and configuring a machine with metadata from the secured configuration file according to an embodiment of the invention.

FIG. 3 illustrates a block diagram of an exemplary configuration manager extracting metadata from a secured configuration file and populating settings fields on a machine to configure the machine according to an embodiment of the invention.

FIG. 4 illustrates a user accessing an exemplary secured webpage to create a secured configuration file according to an embodiment of the invention.

FIG. 5 illustrates an exemplary machine with an embedded configuration manager and a configuration manager stored on a removable medium being accessed by the machine according to an embodiment of the invention.

FIG. 6 is a flow chart illustrating an exemplary method for configuring a machine according to an embodiment of the invention.

FIG. 7 is a flow chart illustrating an exemplary method for configuring a machine according to another embodiment of the invention.

### DETAILED DESCRIPTION

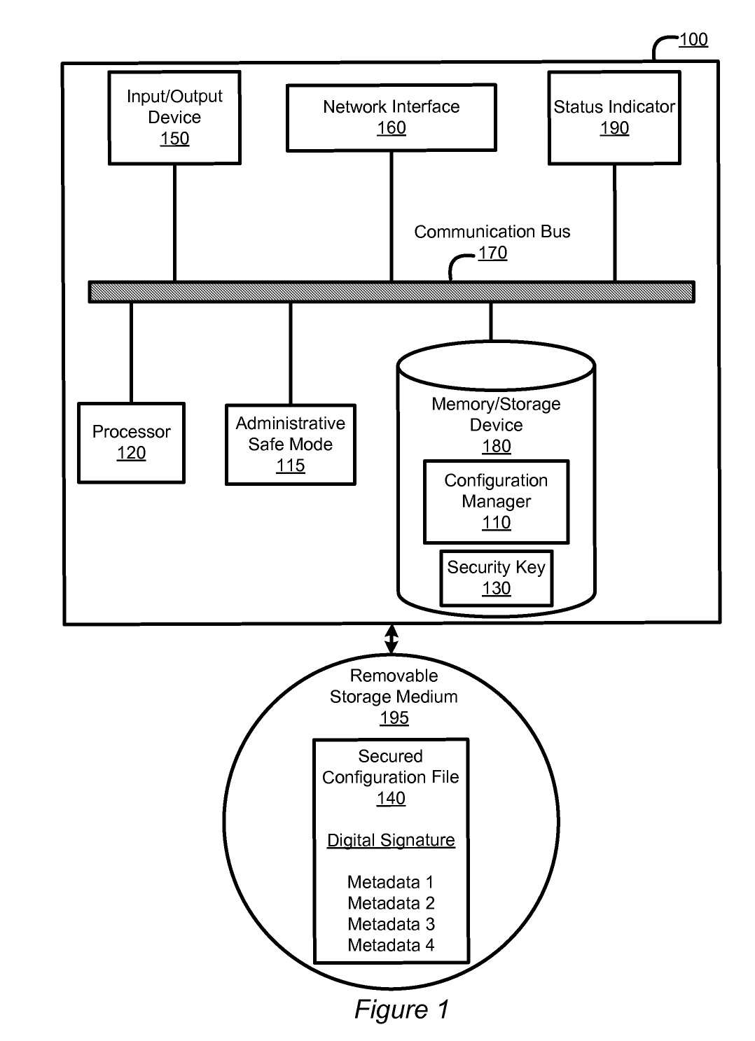

FIG. 1 illustrates a machine 100 with a security key 130 coupled to a removable storage medium 195 and a secured configuration file 140 stored on the removable storage medium 195 according to an embodiment of the invention. In one embodiment, the machine 100 is a desktop, a laptop, a server, and/or any device that a removable storage medium 195 can be coupled to. As illustrated in FIG. 1, the machine 100 includes a processor 120, one or more input devices 150, a memory/storage device 180, a network interface 160, a status indicator 190, and a communication bus 170 for the machine 100 and/or one or more components of the machine 100 to communicate with one another.

Additionally, as illustrated in FIG. 1, the machine 100 is coupled to a removable storage medium 195 that stores a secured configuration file 140. Further, the memory/storage device 180 stores a configuration manager 110 and a security key 130. In other embodiments, the machine 100 includes additional components and/or is coupled to additional components in addition to and/or in lieu of those noted above and illustrated in FIG. 1.

As noted above, the machine 100 includes a processor 120. The processor 120 sends data and/or instructions to the components of the machine 100, such as one or more input devices 150, the status indicator 190, and the configuration manager 110. Additionally, the processor 120 receives data and/or instruction from components of the machine 100, such as the configuration manager 110.

The configuration manager 110 detects when a removable storage medium 195 is coupled to and/or attached to the machine 110 and attempts to authenticate a secured configuration file 140 on the removable storage medium 195 with the security key 130 on the machine 100. The removable storage medium 195 is any device that can store data, such as the configuration file 140, that the machine 100 can couple and/or attach to. In one embodiment, the removable storage medium 195 is a compact disc or a digital versatile disc. In another embodiment, the removable storage medium 195 is a universal serial bus drive and/or any external hard drive. Once the secured configuration file 140 has been authenticated the configuration manager 110 will launch an administrative safe mode 115 and extract metadata from the secured configuration file 140 to configure one or more settings on the machine 100.

In one embodiment, the configuration manager 110 is firmware that is embedded onto the machine 100. In other embodiments, the configuration manager 110 is a software application stored on the machine 100 within ROM or on the memory/storage device 180 accessible by the machine 100 or the configuration manager 110 is stored on a computer readable medium 195 readable and accessible by the machine 100 from a different location. Additionally, in one embodiment, the memory/storage device 180 is included in the machine 100. In other embodiments, the storage device 180 is not included in the machine 100, but is accessible to the machine 100 utilizing a network interface 160 included in the machine 100. The network interface 160 may be a wired or wireless network interface card.

In a further embodiment, the configuration manager 110 is stored and/or accessed through a server coupled through a local area network or a wide area network. The configuration manager 110 communicates with devices and/or components coupled to the machine 100 physically or wirelessly through a communication bus 170 included in or attached to the machine 100. In one embodiment the communication bus 170 is a memory bus. In other embodiments, the communication bus 170 is a data bus.

As noted above, the configuration manager 110 detects when a removable storage medium 195 is coupled to the machine 110. The configuration manager 110 utilizes the communication bus 170 to scan one or more buses, channels, and/or ports for the coupling and/or attachment of the removable storage medium 195. Once the configuration manager 110 has detected the coupling and/or attachment of the removable storage medium 195, the configuration manager 100 will scan the removable storage medium 195 for a secured configuration file 140.

The secured configuration file 140 is a file that includes metadata that can be used to configure one or more settings on the machine 100. Additionally, the secured configuration file 140 includes header fields which specify which of the settings on the machine 100 to configure. Further, the header fields have corresponding metadata fields. The metadata fields in the secured configuration file 140 include metadata that can be used by the configuration manager 110 to populate and/or modify settings fields of settings on the machine 100 when configuring the machine 100.

The secured configuration file 140 is stored on the removable storage medium 195. Additionally, the secured configuration file 140 is created by a secured webpage. A user can access the secured webpage manually or a machine can access the secured webpage automatically. The user or the machine can enter configuration settings for the machine 100 by entering information into configuration forms on the secured webpage. In one embodiment, the machine is an additional machine separate from the machine 100 disclosed above. In other embodiments, the machine is the same machine 100 as disclosed above.

The configuration forms include entries displayed on the webpage that the user or the machine 100 can fill out to specify settings for the machine 100. In one embodiment, the settings specified for the machine include network settings for the machine 100, user profile settings for the machine 100, security and permission settings for the machine 100, and/or application settings for the machine 100. In other embodiments, additionally settings for the machine 100 can be entered into the configuration forms.

Once the user completes all or a portion of the configuration forms, the secured webpage creates metadata of the configuration settings entered and stores the metadata of settings for the machine 100 in the secured configuration file 140. The secured webpage then provides security for the secured configuration file 140 by encrypting it with a digital signature. In one embodiment, the digital signature may include one or more sequence of numbers. The digital signature can be created with a signing algorithm provided by the secured webpage. In other embodiments, the digital signature can utilize various additional cryptography methods generated by the secured webpage to encrypt the secured configuration file 140.

Once the secured configuration file 140 has been encrypted by being digitally signed, the secured webpage sends an instruction for the secured configuration file 140 to be automatically downloaded onto the removable storage medium 195. As noted above, the secured configuration file 140 includes metadata of the settings for the machine 100. The secured configuration file 140 includes metadata for at least one from the group consisting of networking settings for the machine 100, security and permission settings for the machine 100, user profiles settings for the machine 100, and application settings for one or more applications on the machine 100.

The metadata on the secured configuration file 140 are data, such as text, entries, binary and/or numerical values, and/or additional settings that correspond to configurable settings on the machine 100. As noted above, the metadata of settings for the machine 100 are stored in metadata fields in the secured configuration file 140.

Further, as noted above, the configuration manager 110 will scan the removable storage medium 195 when the removable storage medium 195 is coupled to and/or attached to the machine 100. If the configuration manager 110 does not detect the secured configuration file 140 on the removable storage medium 195, the configuration manager 110 will continue to scan the removable storage medium 195 for the secured configuration file 140 until it is found or all of the files on the removable storage medium 195 has been scanned.

In one embodiment, the configuration manager 110 will additionally instruct a status indicator 190 coupled to the machine 100 to emit a signal indicating that no secured configuration file 140 was found on the removable storage medium 195. The status indicator 190 can be display device that can output a visual message and/or signal. In one embodiment, the status indicator 190 includes LEDs and/or other lighting devices that can emit a visual message and/or signal. In other embodiments, the status indicator 190 is an audio device that can emit an audio signal.

If the secured configuration file 140 has been detected on the removable storage medium 195 by the configuration manager 110, the configuration manager 110 will attempt to authenticate the secured configuration file 140 with a security key 130 stored on the machine 100.

The security key 130 is a digital certificate used to authenticate the digital signature on the secured configuration file 140. The security key 130 may be a sequence of numbers, a serial number, an identity of the secured webpage or the machine 100, and/or a signature algorithm. The security key 130 is used by the configuration manager 110 on the secured configuration file 140 to determine whether there is a match or whether the secured configuration file 140 can be decrypted with the security key 130. As illustrated in FIG. 1, in one embodiment, the security key 130 is stored on the memory/storage medium 180. In another embodiment, the security key 130 can be stored on additional devices and/or components on the machine 100. In other embodiments, the security key 130 can be stored on another device and can be accessed by the machine 100 using the network interface 160.

If the security key 130 matches the digital signature, the configuration manager 110 will authenticate the secured configuration file 140 and proceed to use the metadata from the secured configuration file 140 to configure the machine 100. In one embodiment, if the security key 130 does not match the digital signature on the secured configuration file 140, the configuration manager 110 can instruct the status indicator 190 to output a failed authentication message. The failed authentication message can be an audible and/or visual message.

If the configuration manager 110 has authenticated the secured configuration file 140, the configuration manager 110 will launch an administrative safe mode 115 on the machine 100. In other embodiments, the configuration manager 110 launches the administrative safe mode 115 before the secured configuration file 140 has been authenticated and after the secured configuration file has been detected on the removable storage medium 195.

The administrative safe mode 115 is a full access mode of the machine 100 that allows settings on the machine 100 to be accessed, configured and/or modified. In one embodiment, the administrative safe mode 115 is a mode of the machine where fewer device drivers and/or fewer applications on the machine 100 are loaded. The settings on the machine 100 that may be configured include, but are not limited to network settings of the machine 100, user profiles for the machine 100, security and permission settings for the machine 100, and/or application settings of the machine 100.

While in the administrative safe mode 115, the configuration manager 110 may access network settings on the machine, user profile settings on the machine 100, security and permission settings of the machine, and/or application settings on the machine 100. Once the configuration manager 110 has accessed one or more of the settings, the configuration manager 110 can populate one or more settings fields in the settings of the machine 100 with corresponding metadata of settings from the secured configuration file 140.

In launching the administrative safe mode 115, the configuration manager 110 can configure an operating system on the machine 100 to launch the administrative safe mode 115. In another embodiment, the administrative safe mode 115 is separate from the operating system of the machine 100 and the configuration manager will configure the machine 100 to exit the operating system and launch the administrative safe mode 115. Additionally, the configuration manager 110 may additionally configure the machine 100 to reboot before launching the administrative safe mode 115. In other embodiments, the configuration manager 110 will further launch an installation application while in the administrative safe mode 115. The installation application is an application which can work in conjunction with the configuration manager 110 to extract metadata from the secured configuration file 140 to populate one or more settings fields on settings of the machine 100 that header fields in the secured configuration file 140 have identified to configure.

Once in the administrative safe mode 115, the configuration manager 110 can independently or in conjunction with the installation application proceed to identify one or more settings on the machine 100 to configure. In identifying one or more settings on the machine 100, the configuration manager 110 will scan header fields in the secured configuration file 140 for one or more settings on the machine 110 specified to configure.

As noted above, one or more settings on the machine 100 are specified to be configured when the corresponding setting on the machine 110 is listed in any of the header fields of the secured configuration file 140. If the configuration manager 110 finds that any of the settings on the machine 100 are listed, the configuration manager 110 will access the specified setting on the machine 100 and the settings fields for the specified setting on the machine 100. Once the configuration manager 110 has accessed the settings field for the specified setting on the machine 100, the configuration manager 110 will access and extract the corresponding metadata for the specified setting, listed in a corresponding metadata field, and proceed to copy the corresponding metadata over to the corresponding settings field for the specified setting on the machine 100.

In one embodiment, the configuration manager 110 will use the corresponding metadata to overwrite any existing data in the corresponding settings field for the specified setting on the machine 100. In another embodiment, the configuration manager 110 will use the corresponding metadata as a template and proceed to modify any existing data, entries, and/or values in the corresponding settings field on the machine 100 until the data, entries, and/or values in the corresponding settings field for the specified setting on the machine 100 match the corresponding metadata from the secured configuration file 140.

Once the configuration manager 110 has finished configuring a specified setting, the configuration manager 110 will proceed to identify additional settings on the machine 100 that header fields in the secured configuration file 140 specify to configure using the method disclosed above. Once all of the specified settings on the machine 100 have been configured, the configuration manager 110 proceeds to exit the administrative safe mode 115 and the process of configuring the machine 100 is complete. In one embodiment, the configuration manager 110 additionally instructs the status indicator 190 on the machine to output a visual and/or audio message indicating that the machine 100 has been configured successfully.

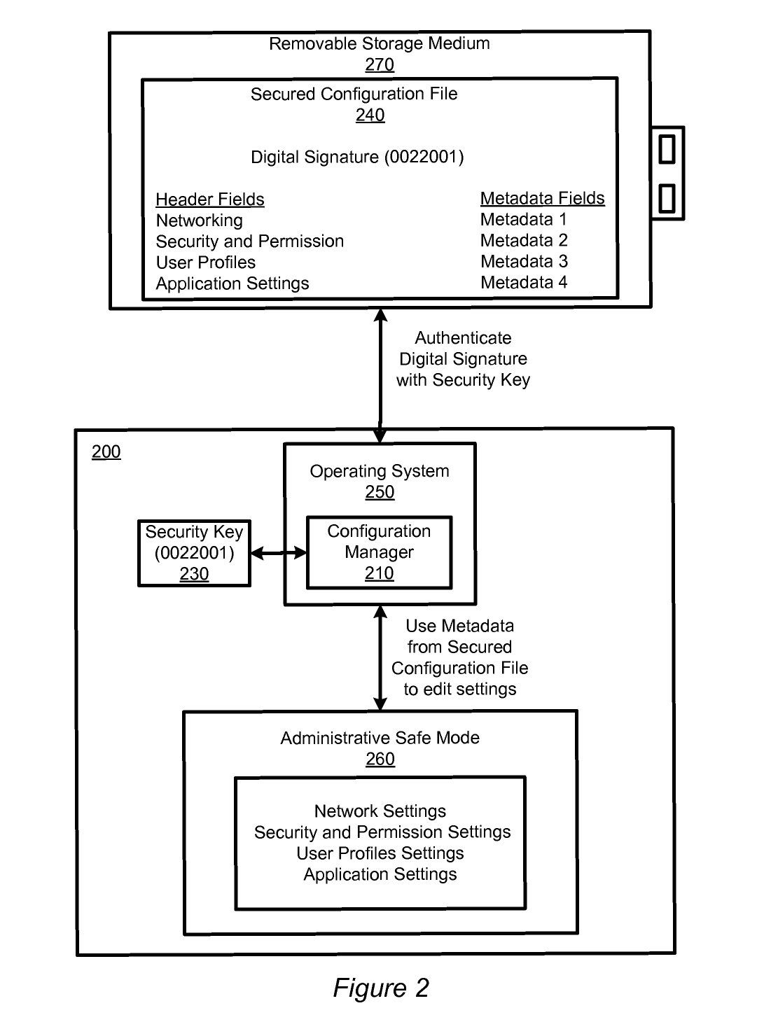

FIG. 2 illustrates a block diagram of a configuration manager 210 authenticating a secured configuration file 240 and configuring a machine 200 with metadata from the secured configuration file 240 according to an embodiment of the invention. As noted above and illustrated in FIG. 2, the secured configuration file 240 includes a digital signature, header fields, and metadata fields.

Additionally, as noted above, the secured configuration file 240 is stored on a removable storage medium 270. Further, as noted above, in one embodiment, the removable storage medium 270 is a USB drive. Once the machine 200 detects the coupling and/or attachment of the removable storage medium 270, the configuration manager 210 on the machine 200 begins to scan the removable storage medium 270 for the secured configuration file 240. As noted above, once the secured configuration file 240 is found, the configuration manager 210 will attempt to authenticate the digital signature from the secured configuration file 240 with a security key 230 on the machine 200.

As noted above and illustrated in FIG. 2, in one embodiment, the digital may include a sequence of numbers, 0022001. Additionally, as noted above, the sequence of numbers may have been created using one or more encryption algorithms. Further, as noted above, the secured configuration file 240 can be authenticated if the digital signature of the secured configuration file 240 matches the security key 230. As illustrated in FIG. 2, the security key 230 includes the sequence of numbers, 0022001. As a result, the digital signature from the secured configuration file 240 matches the security key 230 on the machine 200 and the secured configuration file 240 is authenticated by the configuration manager 210.

Further, as noted above and as illustrated in FIG. 2, once the secured configuration file 240 has been authenticated, the machine 200 can launch an administrative safe mode 260 on the machine 200 so that metadata from the secured configuration file 240 can be extracted and used configure settings on the machine 200. As noted above and as illustrated in FIG. 2, the settings that can be edited on the machine 200 include, but are not limited to, network settings, security and permission settings, user profile settings, and/or application settings.

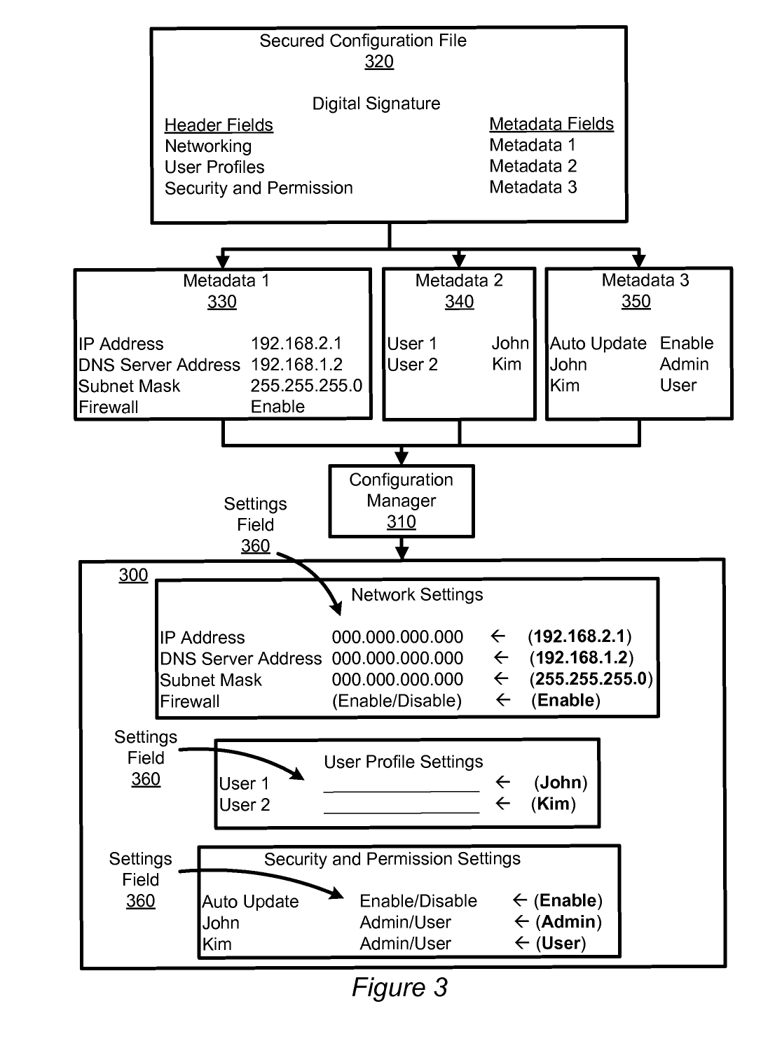

FIG. 3 illustrates a block diagram of a configuration manager 310 extracting metadata from a secured configuration file 320 and populating settings fields 360 on a machine 300 to configure the machine 100 according to an embodiment of the invention. As noted above and illustrated in FIG. 3, the secured configuration file 320 includes header fields which specify which of the settings on the machine 300 to configure. Additionally, as illustrated in FIG. 3, the header fields have corresponding metadata fields which include metadata that are used when configuring specified settings on the machine 300.

As noted above, in one embodiment, the configuration manager 310 will initially authenticate the secured configuration file 320 with a security key on the machine 300. Once the secured configuration file 320 has been authenticated, the configuration manager 310 will proceed to determine which of the settings on the machine 300 to configure by scanning the header fields in the secured configuration file 320.

As shown in FIG. 3, in one embodiment, the header fields in the secured configuration file 320 specify that the networking setting on the machine 300 is to be configured using metadata 1 330. The configuration manager 310 will access the network settings on the machine 100 and then extract metadata 1 330 from the secured configuration file 320 in order to configure the network settings of the machine 300. As shown in FIG. 3, metadata 1 330 lists that that the IP address to be used is 192.168.2.1, the DNS address to be used is 192.168.1.2, the subnet mask to be used is 255.255.255.0, and that the firewall is to be enabled. As shown in FIG. 3, the configuration manager 310 accesses settings fields 360 on the network settings of the machine 300 and proceeds to overwrite the default or empty IP Address, DNS Server Address, and the Subnet Mask. Additionally, the configuration manager 310 chooses to enable the Firewall.

After the configuration manager 310 has finished configuring the networking settings of the machine 300, the configuration manager 310 proceeds to scan the header fields in the secured configuration file 320 for any additional settings on the machine 300 to configure. As illustrated in FIG. 3, the header fields additionally list that the user profiles setting of the machine 300 is to be configured with metadata 2 340. As a result, the configuration manager 310 accesses the user profile setting on the machine and extracts metadata 2 340. Metadata 2 340 specifies that two user accounts are to be created for the machine 300. The configuration manager 310 then accesses the corresponding settings fields 360 for the user profile settings on the machine 300 and proceeds to create a user account for John and a user account for Kim by filling out the corresponding settings fields 360 for the machine's 300 user profile settings.

Once the configuration manager 310 has finished creating user accounts for each of the users listed in metadata 2 340, the configuration manager 310 proceeds to scan the header fields in the secured configuration file 320 for any additional specified settings on the machine 300 to configure. As illustrated in FIG. 3, the header fields additionally list that the security and permissions setting of the machine is to be configured with metadata 3 350. The configuration manager 310 access the security and permissions settings and then proceeds to extract metadata 3 350 from the secured configuration file 320. As illustrated in FIG. 3, metadata 3 350 specify that Auto Update is to be enabled, John is to be given administrator access, and Kim is to be given limited access as a user.

Additionally, as illustrated in FIG. 3, the settings fields 360 of the security and permission settings include predefined options that can be chosen. The Auto Update can be Enabled or Disabled and each of the registered users can be given Admin or User access. As illustrated in FIG. 3, following metadata 3 350, the configuration manager 310 accesses the settings field 360 corresponding to the security and permission settings of the machine 100 and chooses to Enable Auto Updating on the machine 300. Additionally, the configuration manager 310 chooses to give John Admin access and give Kim User access. The configuration manager 310 then scans the header fields on the secured configuration file 320 for any additional settings on the machine 300 to configure. As illustrated in FIG. 3, no additional settings on the machine 300 are listed to be configured, as a result, configuration of the machine 300 is complete.

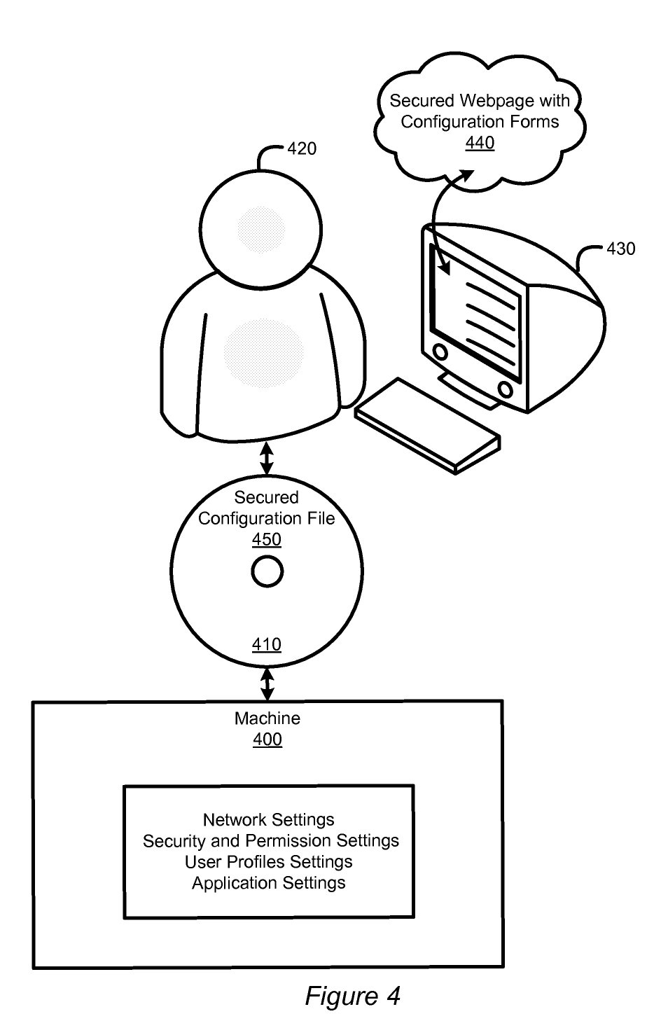

FIG. 4 illustrates a user 420 accessing a secured webpage 440 to create a secured configuration file 410 according to an embodiment of the invention. As noted above and illustrated in FIG. 4, the webpage 440 that the user 420 accesses is secured. Additionally, as noted above, in accessing the secured webpage 440 to fill out configuration forms, in one embodiment, the user 420 can use a separate machine 430 to access the secured webpage 440. In other embodiments, the separate machine or the machine 400 can automatically access the secured webpage 440 without the user to fill out the configuration forms.

In one embodiment, when the secured webpage 440 is accessed, the secured webpage 440 allows the user 420 to manually identify the machine 400 to be configured. In other embodiments, the secured webpage 440 automatically polls the separate machine 430 or the machine 400 for a model of the machine 400 to be configured. Once the secured webpage 440 has identified the machine 400 to be configured, the secured webpage 440 will then generate one or more configuration forms for the user 420 or one of the machines 400, 430 to fill out.

The configuration forms are based on the model of the machine 400 to be configured. As noted above, the configuration forms include entries which correspond to settings on the machine 400. Additionally, the user 420 or one of the machines 400, 430 can specify what settings are to be used on the machine 400 by entering text, values, and/or making selections in the entries of the configuration forms. In one embodiment, the configuration forms include entries for network settings for the machine 400, security and permission settings for the machine 400, user profile settings for the machine 300, and/or application settings for the machine 400.

Once the configuration forms have been filled out, the secured webpage 440 will create metadata of the settings to be used in configuring the machine 400 and store the metadata in the configuration file 450. As noted above, the secured webpage 440 will additionally encrypt the configuration file to create a secured configuration file 450. Additionally, as noted above and illustrated in FIG. 4, the secured configuration file 450 will be automatically downloaded from the secured webpage 440 onto a removable storage medium 410. The secured webpage 440 can automatically initiate the transfer of the configuration file 450 to the removable storage medium 410. The removable storage medium 410 can then be coupled and/or attached to the machine 400 to configure the machine 400.

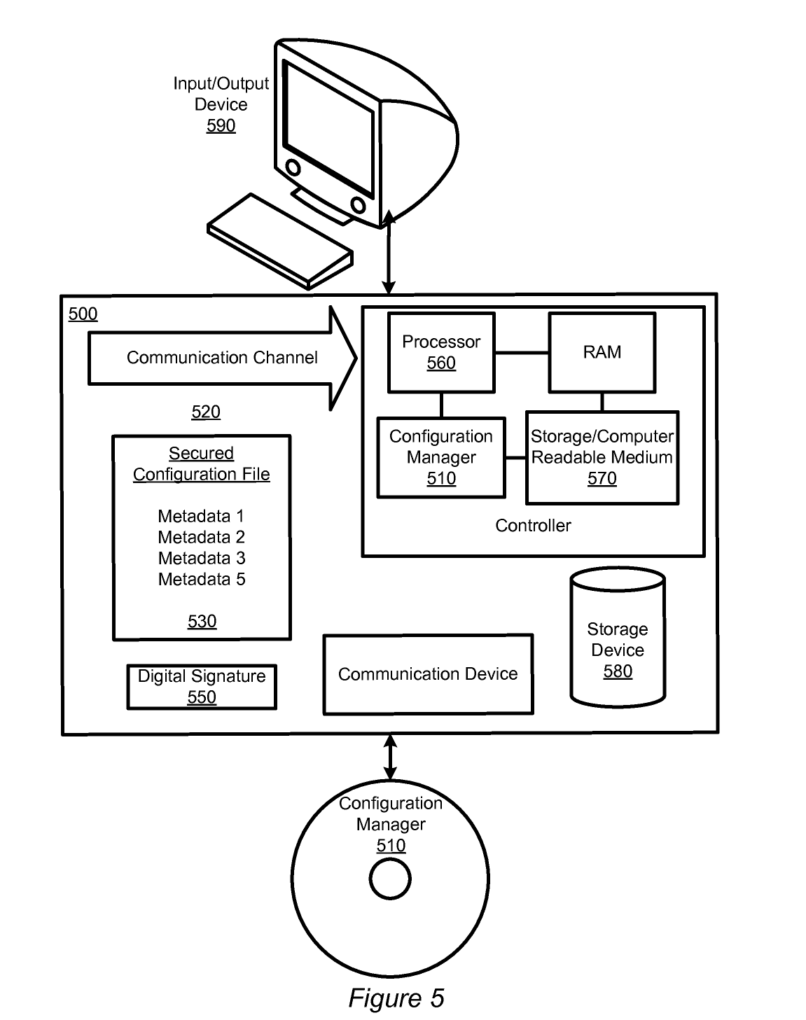

FIG. 5 illustrates a machine with an embedded configuration manager 510 and a configuration manager 510 stored on a removable storage medium being accessed by the machine 500 according to an embodiment of the invention. For the purposes of this description, a removable medium is any tangible apparatus that contains, stores, communicates, or transports the application for use by or in connection with the machine 500. As noted above, in one embodiment, the configuration manager 510 is firmware that is embedded into one or more components of the machine 500 as ROM. In other embodiments, the configuration manager 510 is a software application which is stored and accessed from a hard drive, a compact disc, a flash disk, a network drive or any other form of computer readable medium that is coupled to the machine 500.

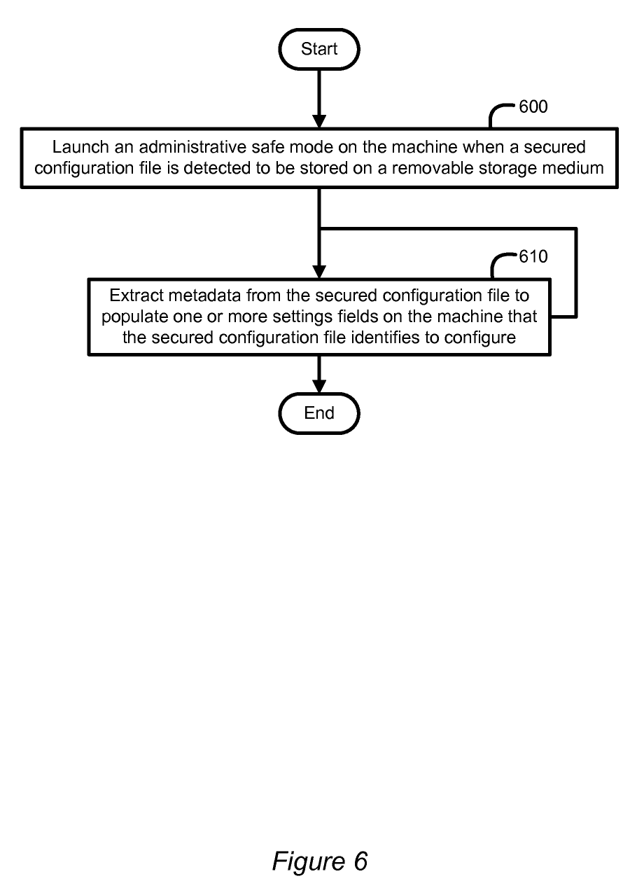

FIG. 6 is a flow chart illustrating a method for configuring a machine according to an embodiment of the invention. The method of FIG. 6 uses a configuration manager on a machine that configures the machine with metadata from a secured configuration file when the secured configuration file is detected to be stored on a removable storage medium coupled and/or attached to the machine. In other embodiments, the method of FIG. 6 uses additional components and/or devices in addition to and/or in lieu of those noted above and illustrated in FIGS. 1, 2, 3, 4, and 5.

As noted above, the configuration manager will launch an administrative safe mode on the machine when a secured configuration file is detected to be stored on a removable storage medium 600. In one embodiment, the administrative safe mode is a full access mode on the machine where the settings on the machine can be accessed, configured and/or modified. Additionally, as noted above, before launching the administrative safe mode, the configuration manager will authenticate the secured configuration file by comparing a digital signature of the secured configuration file to a security key stored on the machine. Further, as noted above, in one embodiment, the secured configuration file can be created from a user or a machine accessing a secured webpage and filling out configuration forms on the secured webpage for the machine to be configured.

Once the configuration manager has authenticated the secured configuration file, the configuration manager will proceed to identify settings on the machine that the secured configuration file specifies to configure. As noted above, one or more settings of the machine are specified to be configured if the corresponding setting is listed in one of the header fields of the secured configuration file. Additionally, as noted above, the header fields have corresponding metadata fields that list corresponding metadata that is to be used when configuration the specified setting on the machine.

Once a setting has been identified to be configured, the configuration manager will proceed to configure the machine by extracting metadata from the secured configuration file to populate one or more settings fields on the machine that the secured configuration file identifies to configure 610. As noted above, the configuration manager will access the identified setting on the machine and a settings field corresponding to the identified setting when populating one or more of the settings fields with metadata from the configuration file. The configuration manager continues this process until each of the specified settings on the machine has been configured with metadata from the secured configuration file 610. In other embodiments, the method of FIG. 6 includes additional steps in addition to and/or in lieu of those depicted above.

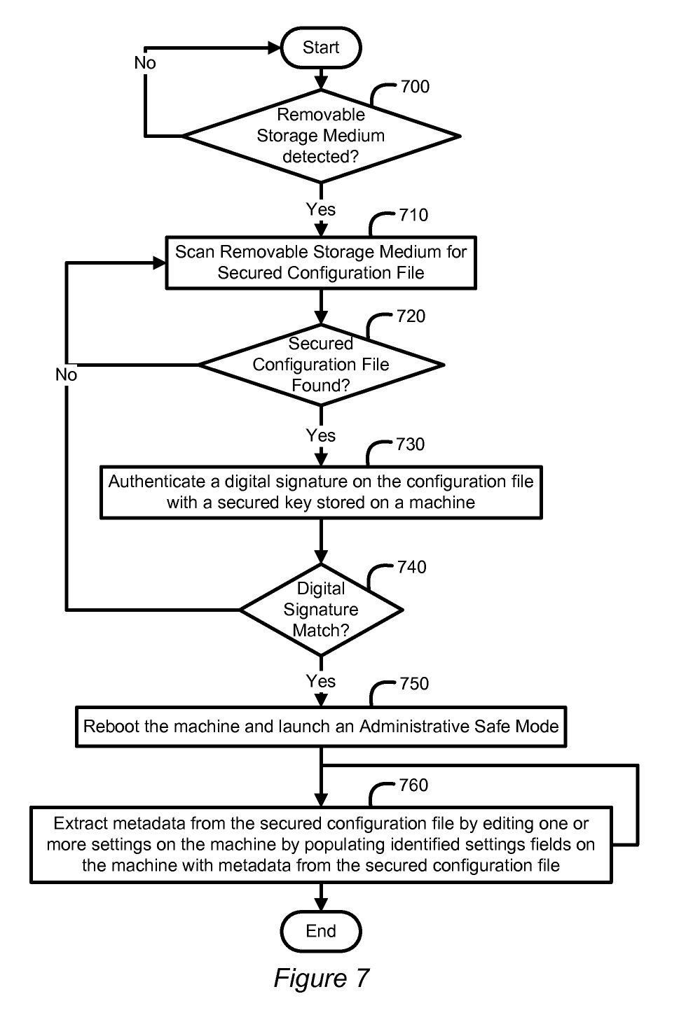

FIG. 7 is a flow chart illustrating a method for configuring a machine according to another embodiment of the invention. Similar to the method of FIG. 6, the method of FIG. 7 uses a configuration manager on a machine that configures the machine with metadata from a secured configuration file when the secured configuration file is detected to be stored on a removable storage medium coupled and/or attached to the machine. In other embodiments, the method of FIG. 7 uses additional components and/or devices in addition to and/or in lieu of those noted above and illustrated in FIGS. 1, 2, 3, 4, and 5.

As noted above, in one embodiment, the configuration manager will initially determine whether a removable storage medium is detected 700. In detecting the removable storage medium, the configuration manager will scan one or more buses, channels, and/or ports on the machine for the removable storage medium being coupled and/or attached to the machine. If no removable storage medium is detected, the configuration manager will continue to scan one or more communication buses, channels, and/or ports on the machine for the removable storage medium.

Once the configuration manager has determined that a removable storage medium has been coupled and/or attached to the machine, the configuration manager will proceed to scan the removable storage medium for a secured configuration file 710. The configuration manager will determine whether the secured configuration file is found to be stored on the removable storage medium 720. If the secured configuration file is not found, the configuration manager will continue to scan the removable storage medium for the secured configuration file 710. In one embodiment, if more than one removable storage medium is determined to be coupled to the machine, the configuration manager can concurrently or sequentially scan each removable storage medium for a secured configuration file.

In other embodiments, if a secured configuration file is not found, the configuration manager can halt scanning and resume scanning the removable storage medium when content on the removable storage medium is updated or when an additional storage medium is coupled to the machine. Additionally, the configuration manager can instruct a status indicator coupled to the machine to output a visual or auditory message indicating that no secured configuration file was found.

If a secured configuration file is found to be stored on the removable storage medium, the configuration manager will attempt to authenticate a digital signature on the secured configuration file with a secured key stored on the machine 730. As noted above, the secured configuration file will be created, secured, and encrypted by a secured webpage. Additionally, as noted above, the secured webpage can be accessed manually by a user on an additional machine or automatically by the machine or the additional machine. Further, various encryption schemes can be used to generate digital signatures when securing the configuration file. Additionally, as noted above, in one embodiment, the secured key is stored on a memory/storage device on the machine.

The configuration manager will determine whether there is a digital signature match between the encryption scheme on the configuration file and the secured key 740. If the secured key does not match the encryption scheme, the configuration manager will reject the use of the secured configuration file and proceed to scan the removable storage medium for any additional secured configuration files 710. Additionally, as noted above, the configuration manager can additional instruct the status indicator to output a visual and/or auditory failed authentication message.

In one embodiment, if the secured key matches the encryption scheme, the configuration manager will proceed to reboot the machine and launch an administrative safe mode 750. In other embodiments, the configuration manager can launch the administrative safe mode without rebooting the machine. As noted above, the administrative safe mode is a full access mode on the machine where the configuration manager is given administrative rights to access, modify, and configure settings on the machine. Additionally, as noted above, in one embodiment, the configuration manager can additionally launch an installer while in the administrative safe mode in order to configure one or more settings on the machine.

As noted above, in configuring one or more settings on the machine, the configuration manager extracts metadata from the secured configuration file to edit one or more settings on the machine by populating identified settings fields on the machine with metadata from the secured configuration file 760. Before extracting the metadata from the secured configuration file, the configuration manager identifies which settings on the machine are to be configured and which metadata on the secured configuration file to use when configuring the corresponding setting.

As noted above, the configuration manager scans header fields on the secured configuration file to determine which settings on the machine is listed to configure. Once, the configuration manager has identified which setting on the machine to configure, the configuration manager will access the corresponding setting on the machine and a settings field for the corresponding setting. As noted above, the header fields have corresponding metadata fields which list the corresponding metadata to be used on the settings field of the corresponding setting. As a result, the configuration manager will extract the corresponding metadata from the secured configuration file. Additionally, in populating the identified settings fields for the corresponding setting, the configuration manager can copy data, text, values, and/or other additional information from the corresponding metadata to overwrite or populate the settings field. In one embodiment, if the settings fields have predefined choices, the configuration manager can use the corresponding metadata as a template and choose one of the predefined choices, as listed in the corresponding metadata.

The configuration manager will repeat the process of identifying settings on the machine to configure and extract corresponding metadata from the secured configuration file for each specified setting on the machine until all of the specified settings have been configured 760. In other embodiments, the method of FIG. 7 includes additional steps in addition to and/or in lieu of those depicted in FIG. 7.

By populating specified settings fields of a machine with metadata from a secured configuration file, the machine can effectively and efficiently be configured without overwriting an image on the machine. Additionally, by authenticating the secured configuration file with a security key on the machine before configuring the machine with the secured configuration file, security and stability for the machine is increased.

What is claimed is:

1. A method for configuring a machine comprising:
launching an administrative safe mode on the machine when a secured configuration file is detected on a removable storage medium; and
extracting metadata from the secured configuration file to populate one or more settings fields on the machine that the secured configuration file identifies to configure.

2. The method for configuring a machine of claim 1 wherein the secured configuration file includes metadata for at least one from the group consisting of networking settings for the machine, security and permission settings for the machine, user profile settings for the machine, and application settings for the machine.

3. The method for configuring a machine of claim 2 further comprising populating one or more settings fields with metadata of at least one from the group consisting of the network settings of the machine, the security and permission settings of the machine, the user profile settings of the machine, and the application settings of the machine.

4. The method for configuring a machine of claim 1 further comprising identifying one or more settings on the machine to configure by scanning a headers field of the secured configuration file for one or more of the settings.

5. The method for configuring a machine of claim 4 further comprising accessing one or more of the settings on the machine identified by the headers field to be configured.

6. The method for configuring a machine of claim 4 further comprising identifying metadata to be used in configuring one or more of the settings by scanning a metadata field of the secured configuration file for metadata that corresponds to one or more of the settings listed in the headers field.

7. The method for configuring a machine of claim 1 further comprising authenticating a digital signature of the secured configuration file with a secured key before launching the administrative safe mode.

8. The method for configuring a machine of claim 7 wherein the administrative safe mode is separate from an operating system on the machine.

9. The method for configuring a machine of claim 1 further comprising launching an installation application in the administrative safe mode.

10. A machine comprising:
a processor;
a storage device configured to store a security key;
a removable storage medium coupled to the machine and configured to store a secured configuration file which was downloaded from a secured website;
a configuration application executable by the processor from a storage medium and configured to launch an administrative safe mode when the secured configuration file is detected and edit one or more settings on the machine by populating identified settings fields on the machine with metadata from the secured configuration file.

11. The machine of claim 10 further comprising one or more status indicators configured to display a visual message after the machine has successfully been configured with the secured configuration file.

12. The machine of claim 10 wherein the secured configuration file is created by a user accessing the secured webpage and filling out configuration forms for one or more of the settings on the machine.

13. The machine of claim 12 wherein the configuration forms include entries displayed on the secured webpage that the user fills out to specify settings for the machine.

14. The machine of claim 12 wherein the user accesses the secured webpage and downloads the secured configuration file on a separate machine.

15. The machine of claim 10 wherein the secured webpage encodes the configuration file with a digital signature for the secured configuration application to decode and authenticate with the security key.

16. A computer-readable program in a computer-readable medium comprising:
a configuration manager configured scan a removable storage medium for a secured configuration file when the removable storage medium is coupled to a machine;
wherein the configuration manager is additionally configured to launch a administrative safe mode and identify one or more setting on the machine specified to be configuring by the secured configuration file; and
wherein the configuration manager is further configured to configure one or more of the settings on the machine by populating one or more setting fields on the machine with metadata from the secured configuration file.

17. The computer-readable program in a computer-readable medium of claim 16 wherein the configuration file includes one or more header fields which specify one or more of the settings on the machine configure.

18. The computer-readable program in a computer-readable medium of claim 16 wherein one or more of the header fields have corresponding metadata fields which specify which metadata from the configuration file to use when populating one or more of the specified setting fields.

19. The computer-readable program in a computer-readable medium of claim 18 wherein the configuration manager copies the metadata specified by one or more of the metadata fields from the configuration file to one or more of the specified setting fields.

20. The computer-readable program in a computer-readable medium of claim 18 wherein the configuration manager chooses a predefined option listed in one or more of the settings fields in response to the metadata specified by one or more of the metadata fields.
